(19) United States
(12) Patent Application Publication
(10) Pub. No.: US 2012/0023085 A1
(43) Pub. Date: Jan. 26, 2012

(54) SOCIAL GRAPH SEARCH SYSTEM

(76) Inventors: Luc BELLERIVE, Longueuil (CA); Martin AUBUT, Montreal (CA)

(21) Appl. No.: 13/189,120

(22) Filed: Jul. 22, 2011

Related U.S. Application Data
(60) Provisional application No. 61/366,597, filed on Jul. 22, 2010.

(51) Int. Cl. G06F 17/30

(52) U.S. Cl. 707/706; 707/E17.108

(57) ABSTRACT

A social graph search system is in communication with a social network website in order to provide customized search results based on the social network of a particular user, including appreciation information associated to each business listing and demographic information retrieved from the social network.

### FIELD OF THE INVENTION

The present invention relates to the field of social graph systems. More particularly, the present invention relates to a social graph system for an online search tool such as an online directory or entertainment verticals. The present invention also relates to a method associated to the above-mentioned system.

### BACKGROUND OF THE INVENTION

Known in the art are various online search systems, such as for example online directories of business listings for obtaining information on a business. Such directories are typically accessible over the Internet to remote users and provide a search engine for searching among the business listings. Typically a user enters search parameters (example: business name and location), in order to obtain a list of corresponding business listings, each listing including information on a particular business, such as a telephone number, an address, a facsimile number, a website, an email address, a map, etc. However, upon obtaining search results, the user may be interested to have information on the satisfaction level of customers of each particular business, in order to help choosing among the business listings resulting from the search.

Also known in the art are various websites where users may enter reviews and/or an appreciation rating (for example: a number of stars out of 5), typically on a product, a service, etc., which is then reflected on the website in association with the particular item (i.e. product, service, etc.). Such reviews may be provided as an average of ratings entered by users as well as details of the ratings and reviews. Though such a system provides an indication of the appreciation level of a business, the user has little information on the source users having entered the reviews, for example on their demographic characteristics of each user and their particular rating or review, and thus the rating or review information may be of little relevance to the user.

Also known in the art are social networking websites, such as Facebook™ for example, allowing users to connect online with other users (“friends”), thereby creating an online network of friends (or “social network”) with which the user can interact. For example, the user may broadcast information to the network of friends. Such information may include messages, photos, event invitations, links, etc. which is visible to each of the friends when they sign on to their respective Facebook™ accounts. Facebook™ uses a “wall” or a “News Feed” to post such broadcasted information. For each post, a friend may provide a comment or indicate that he/she “likes” the post (by clicking on a corresponding link), which will in turn update the “Wall” or “News Feed” to appear in connection with the corresponding post. Facebook™ also includes features allowing a user to create and join interest groups, and to identify him/herself as a “fan” of a group, company, event, etc. Such information would be of particular relevance to a user looking to choose a business among listings, however, this information is not readily available on most online business directories.

Known to the Applicant is U.S. Pat. No. 7,788,260 B2 (LUNT et al.), as well as United States Patent Applications Nos. 2009/0281988 A1 (YOO); 2009/0234848 A1 (LEFF et al.); 2010/0082593 A1 (SINGH); 2010/0185610 A1 (LUNT et al), 2006/0004892 A1 (LUNT et al.), 2009/0282002 A1 (REEDER et al.), 2010/0223134 A1 (LUNENFELD); 2011/0087658 A1 (LUNT et al.); 2010/0121849 (GOELDI); 2010/0332330 A2 (GOEL et al.); 2010/0312649 A1 (LURIE); 2010/0076850 A1 (PAREKH et al.); 2008/0189169 A1 (TURPIN et al.); and 2010/0063879 A1 (ARARADIAN et al.).

Hence, in light of the aforementioned, there is a need for an improved system which, by virtue of its design and components, would be able to overcome some of the above-discussed prior art concerns.

### SUMMARY OF THE INVENTION

The object of the present invention is to provide a system which, by virtue of its design and components, satisfies some of the above-mentioned needs and is thus an improvement over other related online business directories known in the prior art.

In accordance with the present invention, the above mentioned object is achieved, as will be easily understood, by a social graph search system for an online directory such as the one briefly described herein and such as the one exemplified in the accompanying drawings.

According to an aspect of the present invention, there is provided a social graph search system for an online directory being in communication with a social network system, the social network system defining social accounts, the social graph search system comprising:
central database for storing:
   user accounts having profile information, each user account being associated to one of the social accounts; and
   business listings, each business listing being representative of a business and having associated thereto one or more of said user accounts which define a fan list of the corresponding business; and
a central server being in communication with the database, the central server comprising:
   an input port for receiving a search criterion by a searching user having one of said user accounts and for retrieving corresponding social information from the social network system, said social information including appreciation information and demographic information;
   a search engine being operatively connected to the input port and being in communication with the database for identifying resulting business listings corresponding to the search criterion;
   a comparator for identifying, for each of the resulting business listings, the appreciation information corresponding to the user accounts having demographic information which matches the profile information of said searching user; and
   an output port for outputting the resulting business listings in accordance with the appreciation information.

For example, the resulting business listings may take into account only the appreciation information provided by users of a similar age group as the searcher user. Or the resulting business listing may give more weight to appreciation information submitted by users of the same or similar age group.

Preferably, the profile information and demographic information comprise at least one of: age, age group, gender, ethnicity, marital status, income status, employment status, religion, disability, health information, sexual orientation.

Still preferably, the profile information and demographic information comprise at least one of: geographical location, interest group, political position, political affiliation.

Preferably, the outputting of the resulting business listings comprises displaying the business listings on a screen, the displayed business listing being ranked according to a preference score (i.e. an overall value representing the collective appreciation information of the concerned social accounts), starting from the business listing having the highest preference score.

In the context of the present invention, the expression “matches” means that corresponding information between the profile information and the demographic information of the social account is the same or similar, or has a high percentage of matching information.

According to another aspect of the present invention, there is provided a social graph search method for an online directory having a database comprising user accounts having associated profile information and business listings, the method comprising:
receiving, at an input port, a search criterion by a searching user having a user account;
identifying, by means of a search engine, resulting business listings in the database which correspond to the search criterion;
retrieving, by means of an input port, social information from a social network system, said social information including appreciation information and demographic information;
identifying, for each of the resulting business listings, the appreciation information corresponding to the user accounts having demographic information which matches the profile information of said searching user; and
outputting the resulting business listings in accordance with the appreciation information.

According to another aspect of the present invention, there is provided a processor-readable storage medium for an online directory having a database comprising business listings and user accounts, each user account having associated profile information, the processor-readable product comprising instructions for execution by a processor to:
receive, at an input port, a search criterion by a searching user having a user account;
identify, by means of a search engine, resulting business listings in the database which correspond to the search criterion;
retrieve, by means of an input port, social information from a social network system, said social information including appreciation information and demographic information;
identify, for each of the resulting business listings, the appreciation information corresponding to the user accounts having demographic information which matches the profile information of said searching user; and
output the resulting business listings in accordance with the appreciation information.

According to yet another aspect of the present invention, there is a provided a social graph search system for an online directory being in communication with a social network system, the social network system defining social accounts and respective social networks, the social graph search system comprising:
a central database for storing:
   user accounts, each user account being associated to one of the social accounts and to others of said user accounts according to the corresponding social network; and
   business listings, each business listing being representative of a business and being associated to one or more of said user accounts which define a fan list of the corresponding business; and
a central server being in communication with the database, the central server comprising:
   an input port for receiving a search criterion by a searching user having one of said user accounts and for retrieving corresponding social information from the social network system, said social information including appreciation information;
   a search engine being operatively connected to the input port and being in communication with the database for identifying resulting business listings corresponding to the search criterion;
   a comparator for identifying, for each of the resulting business listings, the appreciation information corresponding to the user accounts of the respective fan list which match the social network of said searching user; and
   an output port for outputting the resulting business listings in accordance with the appreciation information.

According to yet another aspect of the present invention, there is provided a social graph search system for an online directory being in communication with a social network system defining user accounts and one or more related user account associated to each user account. The social graph search system for an online directory comprises:
a central server for retrieving information from the social networking system;
a central database operatively connected to the central server for storing:
   a plurality of business listings, each business listing being representative of a business; and
   a plurality of user accounts for allowing a user of the system to be added to a fan list associated to one of said business, each user account being associated to a network of users, based on the information retrieved from the social networking system; and
a search engine operatively connected to the database for receiving search criteria by a searching user, and in response thereto, presenting corresponding business listings based on appreciation information by a comparison of said fan list with the network of users of said searching user.

By “server” it is meant one or more physical computing device(s), each having one or more processor.

In the context of the present invention, the expression “in communication” or “operatively connected” means reciprocally configured to exchange the necessary information, either within one or more hardware device, either directly or indirectly, either locally or remotely, and this, either over a wire connection or a wireless connection, a network, i.e. local area network (LAN), wide area network (LAN), etc., a temporary connection, and/or any combination thereof. The information is exchanged by way of any suitable communication medium such as for example, a computer-readible storage medium, a radio wave or infrared signal transmission, etc., as well as with any suitable communication protocol(s) for transmitting the necessary data between the components involved.

The “database” is a non-transitory processor-readable storage medium. Moreover, in the context of the present invention the expression “storage medium” may refer to any computer data storage device or assembly of such devices including, for example: a temporary storage unit such as a random-access memory (RAM) or dynamic RAM; a permanent storage such as a hard disk; an optical storage device, such as a CD or DVD (rewritable or write once/read only); a flash memory; and/or the like. A plurality of such storage devices may be provided, as can be understood by a person skilled in the art.

The “search engine” is integrated in a processor which comprises computer-readable data and statements to process search criteria according to information retrieved from the social network system and to output resulting business listings.

This information may include the appreciation information by a comparison of the fan list with the network of users of the searching user. The external information may further include demographics information.

According to another aspect of the present invention, there is provided a method of collecting data in the above-mentioned social graph search system for an online directory.

According to another aspect of the present invention, there is provided a method of presenting business listings in the above-mentioned social graph search system for an online directory.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a diagram showing the social graph search system for an online directory, according to a preferred embodiment of the present invention.

FIG. 2 is a sequence diagram showing scenarios of method of operating the social graph search system, according to preferred embodiments of the present invention.

FIG. 3A and 3B are partial screen captures showing a display of search results generated by the search engine of the social graph search system, according to a preferred embodiment of the present invention, FIG. 3A showing a social results section displayed in the search results.

FIG. 4 is an enlarged view of the social results section shown in FIG. 3A.

FIG. 5 is a partial view of what is shown in FIG. 3A, the social results section being shown in an enlarged view.

FIG. 6 is another partial view of a display of search results generated by the search engine of the social graph search system, according to an embodiment of the present invention, a selected one of search results being shown high-lighted and with a “share” button, and a corresponding window providing associated share options.

FIG. 7 is another partial view of a display of search results generated by the search engine of the social graph search system, according to an embodiment of the present invention, the search results being shown in a result list with a map adjacent thereto, the map displaying “pinpoints” being associated to the result list.

### DETAILED DESCRIPTION OF PREFERRED EMBODIMENTS OF THE INVENTION

In the following description, the same numerical references refer to similar elements. The embodiments, geometrical configurations, materials mentioned and/or dimensions shown in the figures or described in the present description are preferred embodiments only, given for exemplification purposes only.

In the context of the present description, mutually equivalent expressions and/or compound words thereof known in the art will be used interchangeably, as can be understood by a person skilled in the art. Furthermore, the order of the steps of the method described herein should not be taken as to limit the scope of the invention, as the sequence of the steps may vary in a number of ways, without affecting the scope or working of the invention, as can also be understood.

Broadly described, the social graph search system according to the present invention, as exemplified in the accompanying drawings, is in communication with a social network website in order to provide customized search results based on the social network of a particular user, including for example appreciation information of the social network for each business listing. The social network website preferably defines user accounts and one or more friends associated to each user account.

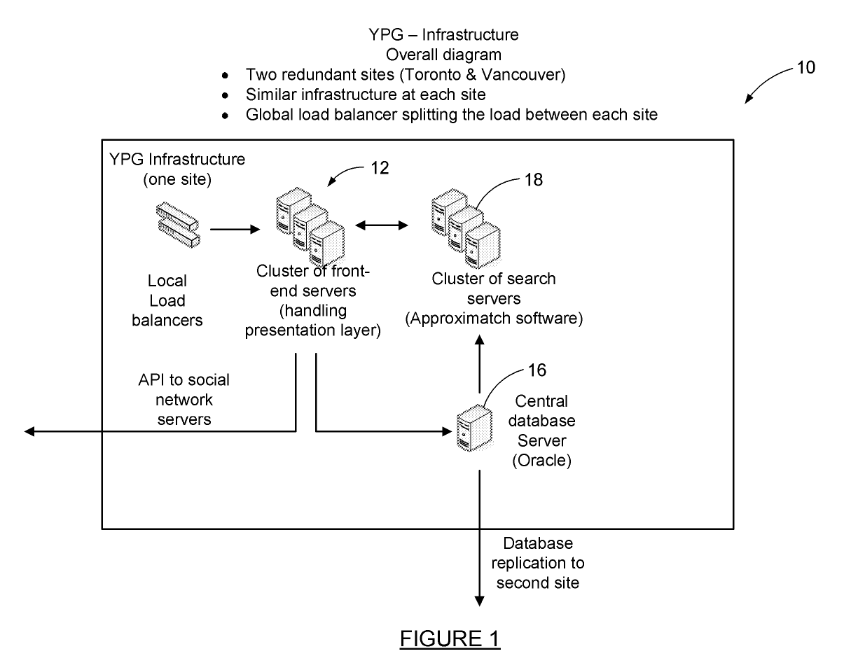

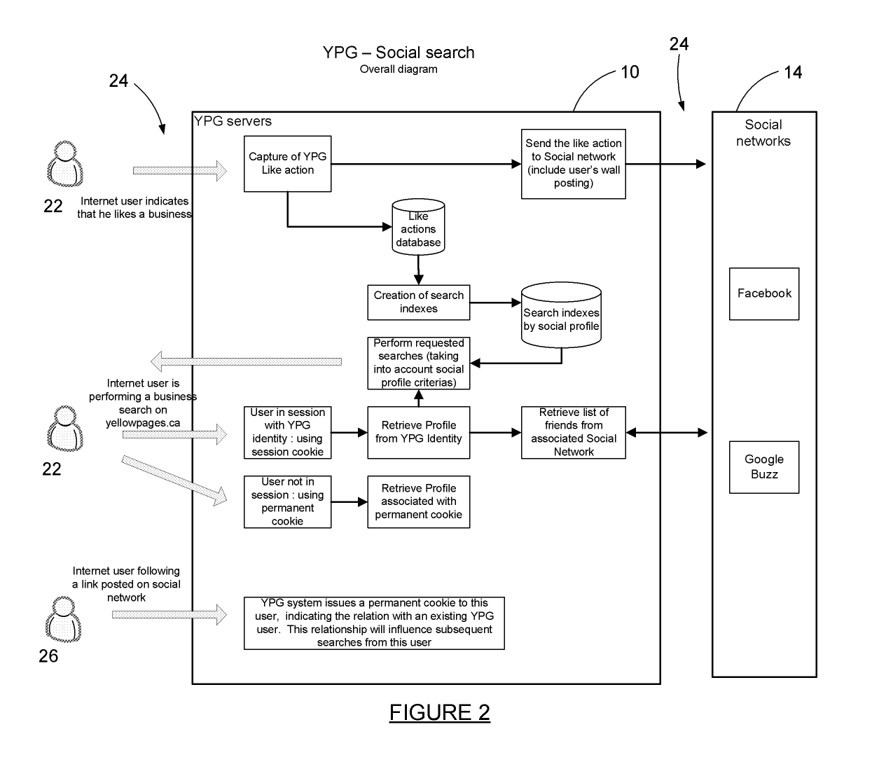

Preferably and as better illustrated in FIGS. 1 and 2, the social graph search system 10 for an online directory of the present invention according to a preferred embodiment comprises:
a server 12 for retrieving information from the social networking system 14;
a central database 16 operatively connected to the server 12 for storing:
   a plurality of business listings, each business listing being representative of a business; and
   a plurality of user accounts for allowing a user of the system to be added to a fan list associated to one of said business, each user account being associated to a network of users, based on the information retrieved from the social networking system; and
a search engine 18 operatively connected to the database 16 for receiving search criteria by a searching user, and in response thereto, outputting/presenting/organizing corresponding business listings based on appreciation information by a comparison of said fan list with the network of users of said searching user.

In other words, the social network website defines user accounts and one or more friends associated to each user account (i.e. network of a particular user). Preferably, and as better illustrated in FIGS. 1 and 2, the social graph search system 10 (the “YPG” system) comprises: a server 12 configured to retrieve information from the social networking system 14; a central database 16 connected to the server 12 for storing therein: business listings (each including information representing a business, such as name, address, telephone number, facsimile number, email address, etc. and each business may have a fan list in the social network system); and user accounts for allowing a user of the system to be added to one of the fan lists (each user account is associated to a network of users, based on the information retrieved from the social networking system); and a search engine 18 operatively connected to the database 16 for receiving search criteria by a searching user, and in response thereto, outputting, presenting and/or organizing corresponding business listings based on appreciation information by a comparison of the fan list with the network of users associated to the searching user.

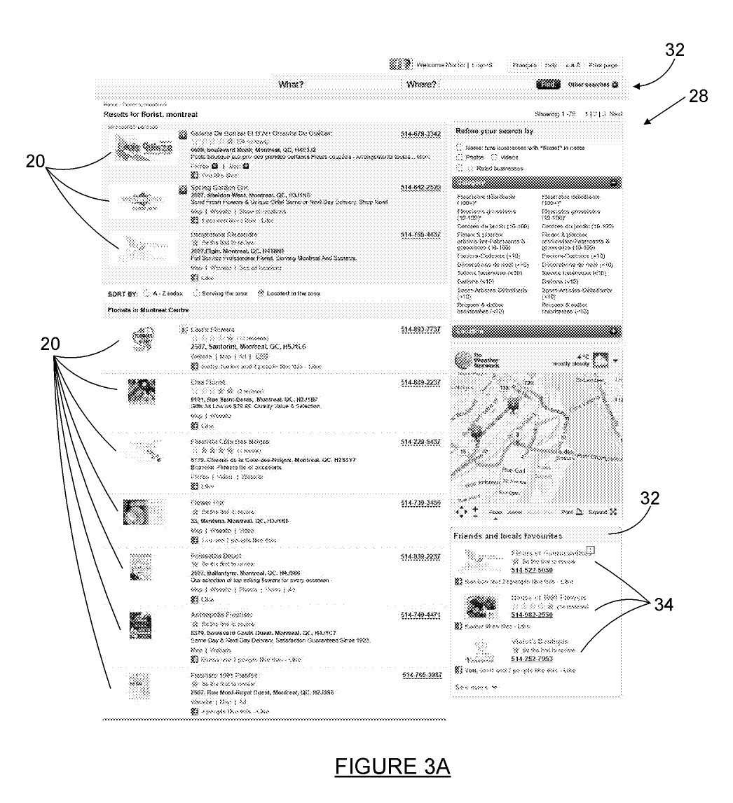

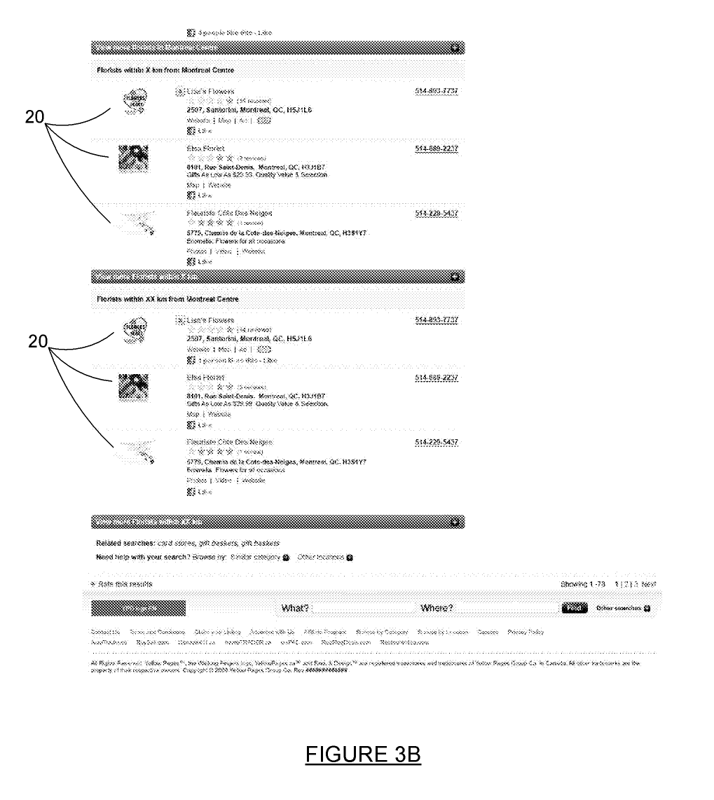

According to an embodiment of the present invention, there is provided an online directory of business listings 20 operated by a service provider. Each business listing 20 displays information on a particular business (or “merchant”), such as a telephone number, an address, a facsimile number, a website, an email address, etc., as exemplified in FIGS. 3A and 3B. The listings 20 are accessible via a search engine, whereby a user may enter search parameters and obtain a list of corresponding business(es) (also referred to herein as “results” or “search results”).

The assignee of the present application is Yellow Pages Group (hereinafter “YPG”) (i.e. the “provider), which owns a “web property” including the following online directories: yellowpages.ca™, Canada411.ca™ and Trader™ (with local search function). The term “online directory” is meant to include any online directory and/or corresponding search engine operated and/or owned by the provider (i.e. YPG in the case of the assignee of the present application). The term “system” or “provider system” or “YPG system” refers to the system of the provider, including the web property (i.e. search engine(s), online directory(ies), etc.) server(s), database(s), data warehouse(s), data network(s), software, data processing unit(s), processes and/or operation(s) run on any of the above, etc.

The business listing data is preferably stored in the central database 16, on a server of the provider. Preferably, each merchant page or business listing 20, corresponding to a business at a given location, is assigned a permanent unique identifier (“merchant-id”), also stored in the central database 16. It is to be understood that the data may alternatively be provided by a plurality of data sources (database(s), data warehouse(s), etc.), which may be stored on one or more server(s), as can be understood by a person skilled in the art. Moreover, some of the data composing the business listing may be generated dynamically (for example, for providing a geographic map based on the address information, etc.). Moreover, the business listings are accessible to remote users 22 (or local users), via a data network 24, for example from a computer or the like, using for example a web browser. By “computer” it is meant any suitable device having a using interface allowing a user to access and use the online directory, for example a personal computer, a laptop, a smartphone, a tablet computer, etc. Moreover, by “browser”, it is meant any suitable means for displaying business listings of the directory and for receiving user input data, such as for example web browsers for displaying pages of the Internet. By data network” it is meant any suitable communication network, such as a WAN, a LAN, a telephone network, a cellular telephone network, a wireless network, etc.

Data Collection

Referring to FIGS. 1 and 2, upon performing a search on a YPG online directory, the user 22 is presented with a list of search results. The user which initiates a search will also be referred to herein as the “original user” or “originating user”. For each result in the list, the user 22 may perform an action in relation to the result item. For example, the user may indicate his appreciation of the associated business, by providing “appreciation information”, also referred to herein as “preference” or “preference information”, which is representative of the user's liking or evaluation of the business. The appreciation information may be provided by the user 22, for example, with a clicking action on a corresponding link, radio button, or the like, in order to indicate that he/she “likes” the business, analogously to the similar feature available with Facebook™. Alternatively, the user may provide appreciation information by way of a rating scale such as a number of stars, a ranking, a boolean value representing whether or not the user appreciates the business (for example, “thumbs up” or “thumbs down”), etc. This functionality may be displayed in any suitable form so as to be associated to the corresponding business listing, (for example: check box, radio button, link, etc.). Moreover, such appreciation information may include a general appreciation value and/or a plurality of values representing appreciation for different aspects of the business (for example, quality, price, etc.). Upon entering the appreciation information, this appreciation information is associated to the corresponding business within the central database 16 of the YPG system. Other actions may include for example, saving information on the result item (example: saving address and telephone number, for later reference), either within the user space of the YPG system or in memory on the user device. Another action may be to share the result item with another user, preferably within his/her social network. Yet another action may be to enter “rating and review” information (R&R).

The YPG system 10 preferably provides user accounts (an “internal user account” or a “YPG account”), each account corresponding to a particular user 22 of the online directory and being identified by a unique “YPG identifier”. The user account may be accessed by entering authentication information, such as a username and a password. Alternatively, the YPG user account may be accessed via an “external” account” of a social networking system such as Facebook™, Twitter™, MS Live™ LinkedIn™, Gmail™, etc. which the user 22 has created. Thus, at the creation of a YPG account, a user 22 may prefer to connect this user account using existing authentication from an external system 14 such as Facebook™. Preferably, the online directory system 10 associates the internal user account with the external user accounts of the same user 22. If the user 22 is not logged into a user account when accessing the online directory 10 and he/she makes an action being representative of an intention to enter his/her appreciation information, the user 22 is preferably prompted to login to a user account (internal or external), or to create a new user account (for example, if the user has no account).

When a user 22 is in session (i.e. logged on to the YPG account, either using internal YPG authentication or external authentication, a session cookie is sent back to his/her browser. This cookie is recognized by a subsequent transaction within the YPG system, for the duration of the session. A session does not expire as long as the browser is active or until the user logs off.

Based on appreciation information provided by a user 22, the user 22 may be identified as a “fan” of a business. Preferably, a user 22 who indicates that he/she “likes” a business is automatically added as a “fan” of the business. Alternatively, the determination that a user is a fan may be made based on the appreciation value in comparison with a predetermined threshold value. Alternatively, the identification that a user is a fan may be optional to him/her, such that the user 22 may enter whether he/she wishes to be identified as a fan of the business, independently of the appreciation information entered (i.e. for example, clicking on the “like” button does not automatically make the user a “fan”). Thus each business listing 20 may be associated to a list of fans. Moreover, a user 22 being a fan of a business may mark him/herself off the list of fans (for example, to reflect a change in his/her appreciation of the business). The list of fans for a business preferably includes, for each fan, the corresponding user identifier (i.e. the internal identifier) and the registration system identifier (i.e. the external identifier). The YPG system further stores another pair of parameters, using the corresponding YPG identity values, namely a combination of business id (also called unique merchant id) and YPG user id. For efficiency of searches, a pair containing business id and social network id are also preferably stored. For example, if a YPG account is linked to a Facebook™ account, when searches are performed by this user, the system retrieves the corresponding list of friends from Facebook™. Facebook then returns the corresponding Facebook user id. It is more efficient for the search engine to use the Facebook internal id to do the match. This information is preferably stored in the central database 16. The search engine index is updated in an incremental mode as new information is captured. Indeed, all searchable content on the YPG system 10 is preferably indexed in advance by the search engine in order to provide adequate response time for online queries. The term “incremental mode” refers to a method of updating the index of the search engine with new or changed data only, instead of a complete reloading of the indexes. This allows near real-time access to new data (e.g. a person indicating that he is a fan of a business)

For users 22 also having an account on a social networking system 14, such as Facebook™, Twitter™, MS Live™, LinkedIn™, Gmail™, etc. the system 10 also posts a message to related users (i.e. “friends” connected to the originating user in the social network), based on the appreciation information entered in the YPG system with respect to a business, in order to allow the user to share his/her preference information with his/her social network 14. For example, the preference information may be posted on a Facebook™ “Wall” or “News Feed”. This message includes a unique link leading to the merchant page of the online directory, for example by presenting the message or a portion thereof in hyperlink format. This link preferably contains parameters on merchant id, user id (either internal or external identifier) of the referrer, i.e. the originating user who performed the “like” action. The intent is that if a new user 26 clicks on this link to view the merchant page on the YPG site 28 (see FIG. 3A et 3B), the YPG system 10 may not recognize this new user 26, but it will know that he/she 26 is a friend (i.e. a related user) of a specific registered YPG user 22 (i.e. the originating user).

When a related user 26 follows this link, the system 10 verifies if this related user 26 already has a YPG Identity cookie, i.e. whether he/she is known to the system 10. In the affirmative, the YPG system 10 establishes an association between the original user 22 and the related user 26 in the central database 16. If this new user 26 (i.e. the related user) does not have a YPG Identity cookie on his/her a local device, the system 10 issues a cookie to the local device. The cookie contains a variable indicating the YPG user identifier of the known user 22, thus allowing the search engine 18 to provide search results based on social criteria, even for users who never registered to a YPG Identity. The system 10 recognizes that the new user 26 is a friend of a registered user 22. This cookie is used to influence subsequent searches on the search engine for the related user. Cookies issued by the system 10 are generally permanent cookie, i.e. with no expiry date. Session cookies, which are valid only for a limit of time and when the browser is active, may be used to allow a user to add content or preferences in the system.

Collection of Profiling Information

Upon an initial registration by a user 22 under his/her YPG Identifier, the system 10 preferably collects user data, which may be limited based on what the user agrees to share and/or, based on what is permissible by an external system 14 (e.g. Facebook™, Openid authentication), if the user 22 has signed in under an external identifier. Each social network site 14 allows to share profile information with authorized systems, based on users' permissions at the initial registration, e.g. Facebook™ asks the user to confirm that he/she authorizes the sharing. The list of what is “permissible” is published by each social site and is expected to evolve. User data collected may include gender, date of birth, city of residence, etc. Such information may be used for subsequent searches to influence the results presented to the user, based on preference information obtained from users having a similar demographic profile, as will be better explained further below. The search engine preferably adapts the search based on information available for a user. Thus users having provided more information lead to results of higher relevance.

The system 10 preferably further provides a functionality (“Claim your listing”) allowing to collect and/or permanently store profiling information for a user 22. According to a preferred embodiment, the YPG system 10 receives basic information from Telco™ for white pages listing. In order to enhance YPG content, a user 22 may confirm that he is the owner of a telephone listing, in order to enhance his/her profile. This is an opportunity to provide more “social profile” information that can be used by the search engine 14. For example, this would provide an exact location to suggest social searches based on his location.

Searches

Referring now to FIGS. 2, 3A and 3B, when a user 22 being in session under his/her YPG identifier, performs a search within one of the YPG online directories 28, the system 10 receives a search request, containing search parameters 30 (for example, a business name or a service in a field identified as “what” and a geographical location in a field identified as “where”). The system validates that the user 22 is in session under his/her YPG identity, by verifying the presence of the associated session cookie. If the user 22 has connected to the YPG system 10 via an external system 14 (e.g. Facebook™ or other social networking site), the system 10 retrieves the network of friends 26 from the external system 14, namely the corresponding user ids, which is then stored temporarily to speed up subsequent requests for the same user during the same day, since this information tends to vary frequently. Preferably, at least a unique identifier from the external system 14, such as a nickname, is retrieved and stored. Additional information may be further copied into the YPG central database 16. This may be done automatically, for example upon accessing the YPG system 10 via an external identifier. Preferably, the data transfer respects privacy settings, permissions, etc. established for the user in the external system. Alternatively, information is copied into the YPG central database upon request or conditional to approval from the user. Additionally, the user may be provided with an option of restricting the list of friends and information being communicated between the external system and the YPG internal system, as can be understood by a person skilled in the art.

In response to a search request made by a user 22, the system 10 returns corresponding search results, as previously explained, in the form of business listings 20. Each business listing 20 may be presented with the following information, when applicable:
Number of total users who “like” the business; and
The list of friends taken from the social network (for example, their nicknames), who “like” the business. The system preferably identifies theses friends by identifying, among the users who are “friends” of the originating user (i.e. related users), those who are also “fans” of the business.

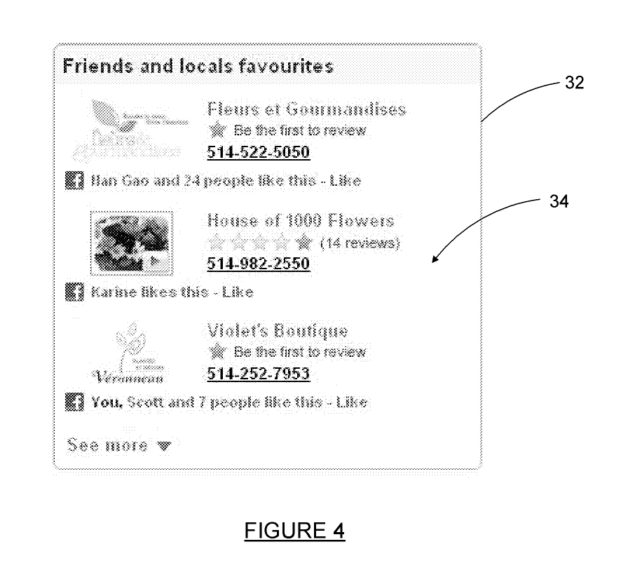

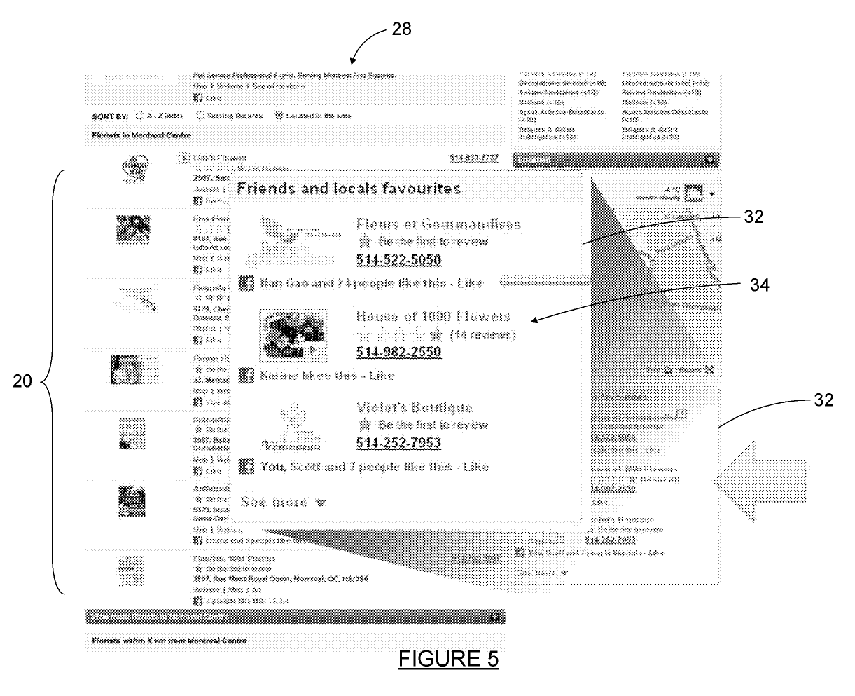

According to an embodiment of the present invention, the search results are displayed within a window including an additional section 32 to display social network related results 34, as better shown in FIGS. 3A, 4 and 5.

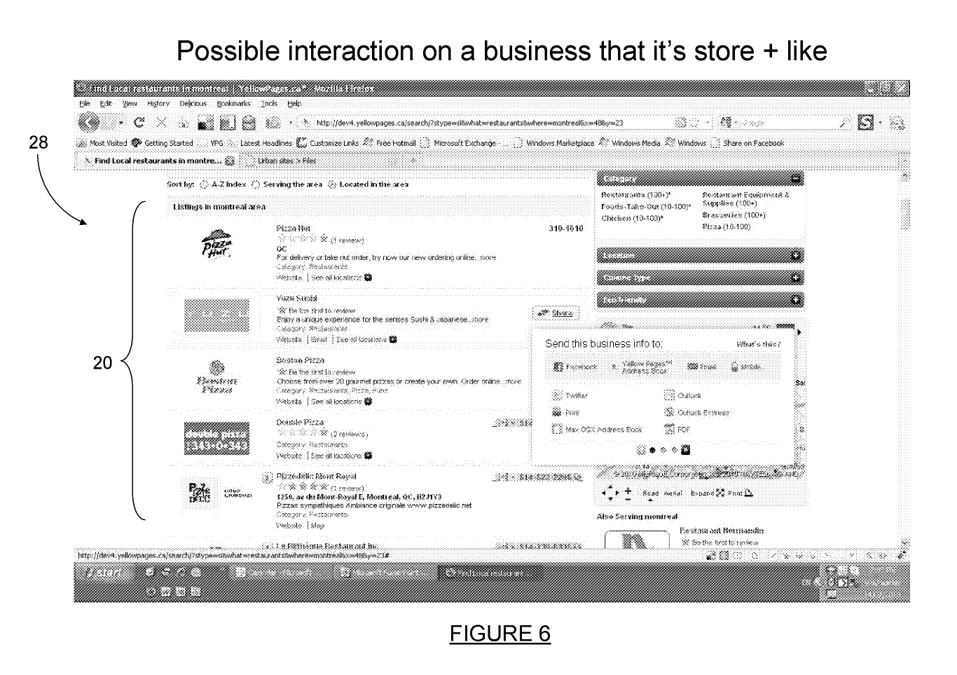

Such social network related results 34 may include listings of preferred businesses for users having a similar demographic profile, by comparing genders, age groups, business preferences, etc., or for users and/or businesses located near the searched location. To achieve efficiency in this type of search, multiple indexes are preferably created for the list of fans of a business, preferably one for each characteristic considered in the filtered search. Indeed, search engine are efficient for online queries only when indexes are created based on type of searches being performed. For example, if search results based on age groups are desired, a specific index is created containing age group (when known) of the user who performed the “like” action, or any other action (for example, saving, sharing, R&R, as previously explained, and/or the like, with reference to FIG. 6) and the corresponding business id.

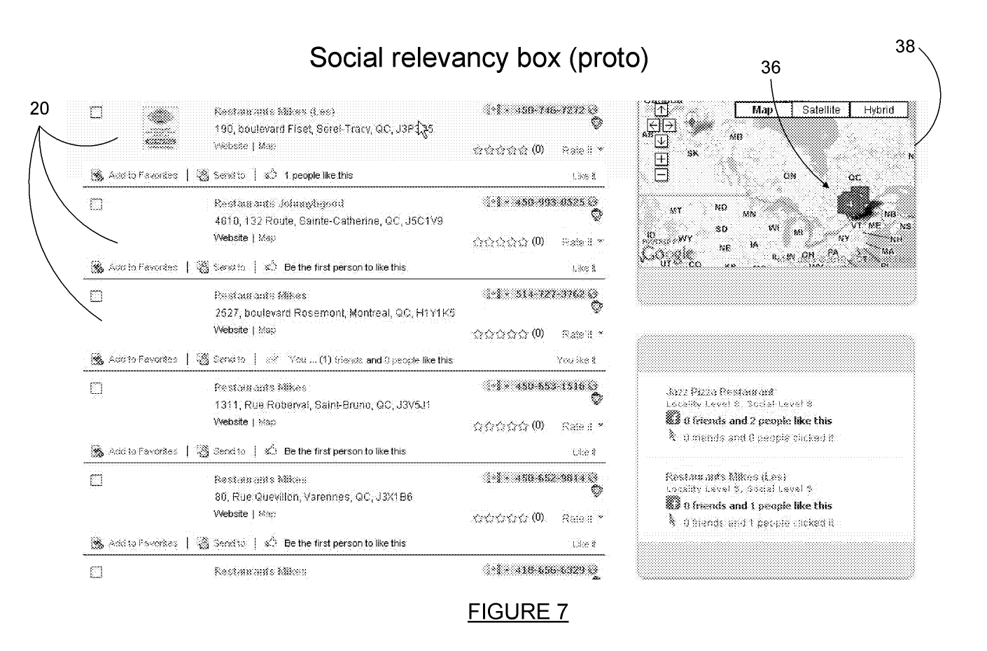

Social network related results 34 may also include listings of preferred businesses for local users, based on location information. The YPG search engine 14 preferably uses a detailed taxonomy and ontology, as well as a series of business rules to determine relevant results and to rank (or prioritize) the results. Thus, the location information may also be considered in the retrieval and presentation of search results. For example, a business listing having a location that is geographically close to the location of the user may be of higher relevance (and thus of higher ranking in the displaying of the search results) than another business having a more remote location. As previously mentioned, other parameters may further be weighed in the evaluation of relevance and ranking of the search results. Once again, to achieve efficiency in such online searches, multiple indexes are preferably created. Every instance of the list of fans of a business is indexed for each region parameter, which may be used to make a search, such as “city”, “polygon”, “neighbourhood”, “Province”, etc. A polygon is a list of geo-coordinates (latitude/longitude) that defines the border of a region. Presentation of social search results may also be map based, as better illustrated in FIG. 7, where selected business listings 20 are presented as pinpoints 36 on a map 38.

Numerous modifications could be made to the above-described social graph search system for an online directory, without departing from the scope of the present invention. The above-described embodiments are considered in all respect only as illustrative and not restrictive, and the present application is intended to cover any adaptations or variations thereof, as apparent to a person skilled in the art.

Moreover, although the present invention provides a social graph search system for an online directory, some of the above-described embodiments may also be applicable to other similar systems for searching among businesses or the like (for example, various online search sites such as for finding restaurants, bars, events, shows, films (cinema), travel/hotel, etc., preferably based on a location), as can also be easily understood by a person skilled in the art, without departing from the scope of the present invention.

The above-described embodiments are considered in all respect only as illustrative and not restrictive, and the present application is intended to cover any adaptations or variations thereof, as apparent to a person skilled in the art. Of course, numerous other modifications could be made to the above-described embodiments without departing from the scope of the invention, as apparent to a person skilled in the art.

1. A social graph search system for an online directory being in communication with a social network system, the social network system defining social accounts, the social graph search system comprising:
a central database for storing:
user accounts, each having profile information, each user account being associated to one of the social accounts; and
business listings, each business listing being representative of a business and having associated thereto one or more of said user accounts which define a fan list of the corresponding business; and
a central server being in communication with the database, the central server comprising:
an input for receiving a search criterion by a searching user having one of said user accounts and for retrieving corresponding social information from the social network system, said social information including appreciation information and demographic information;
a search engine being operatively connected to the input port and being in communication with the database for identifying resulting business listings corresponding to the search criterion;
a comparator for identifying, for each of the resulting business listings, the appreciation information corresponding to the user accounts having demographic information which matches the profile information of said searching user; and
an output for outputting the resulting business listings in accordance with the appreciation information.

2. The social graph search system according to claim 1, wherein said profile information and demographic information comprise at least one of: age, age group, gender, ethnicity, marital status, income status, employment status, religion, disability, health information, sexual orientation.

3. The social graph search system according to claim 1 or 2, wherein said profile information and demographic information comprise at least one of: geographical location, interest group, political position, political affiliation.

4. A social graph search method for an online directory having a database comprising business listings and user accounts, each user account having associated profile information, the method comprising:
receiving a search criterion by a searching user having a user account;
identifying, by means of a search engine, resulting business listings in the database which correspond to the search criterion;
retrieving social information from a social network system, said social information including appreciation information and demographic information;
identifying, by means of a processor, for each of the resulting business listings, the appreciation information corresponding to the user accounts having demographic information which matches the profile information of said searching user; and
outputting the resulting business listings in accordance with the appreciation information.

5. A processor-readable storage medium for an online directory having a database comprising business listings and user accounts, each user account having associated profile information, the processor-readable product comprising instructions for execution by a processor to:
receive a search criterion by a searching user having a user account;
identify, by means of a search engine, resulting business listings in the database which correspond to the search criterion;
retrieve social information from a social network system, said social information including appreciation information and demographic information;
identify, by means of a processor, for each of the resulting business listings, the appreciation information corresponding to the user accounts having demographic information which matches the profile information of said searching user; and
output the resulting business listings in accordance with the appreciation information.

6. A social graph search system for an online directory being in communication with a social network system, the social network system defining social accounts and respective social networks, the social graph search system comprising:
a central database for storing:
user accounts, each user account being associated to one of the social accounts and to others of said user accounts according to the corresponding social network; and
business listings, each business listing being representative of a business and being associated to one or more of said user accounts which define a fan list of the corresponding business; and
a central server being in communication with the database, the central server comprising:
an input for receiving a search criterion by a searching user having one of said user accounts and for retrieving corresponding social information from the social network system, said social information including appreciation information;
a search engine being operatively connected to the input port and being in communication with the database for identifying resulting business listings corresponding to the search criterion;
a comparator for identifying, for each of the resulting business listings, the appreciation information corresponding to the user accounts of the respective fan list which match the social network of said searching user; and
an output for outputting the resulting business listings in accordance with the appreciation information.

7. A social graph search system for an online directory being in communication with a social network system defining user accounts and one or more related user account associated to each user account, the social graph search system comprising:
a central server for retrieving information from the social networking system;
a central database operatively connected to the central server for storing:
a plurality of business listings, each business listing being representative of a business; and
a plurality of user accounts for allowing a user of the system to be added to a fan list associated to one of said business, each user account being associated to a network of users, based on the information retrieved from the social networking system; and
a search engine operatively connected to the database for receiving search criteria by a searching user, and in response thereto, presenting corresponding business listings based on appreciation information by a comparison of said fan list with the network of users of said searching user.
